(19) United States
(12) Patent Application Publication
(10) Pub. No.: US 2014/0062997 A1
(43) Pub. Date: Mar. 6, 2014

(54) PROPORTIONAL VISUAL RESPONSE TO A RELATIVE MOTION OF A CEPHALIC MEMBER OF A HUMAN SUBJECT

(71) Applicants: SAMRAT JAYPRAKASH PATIL, Pune (IN); Sarat Kumar Konduru, Vijayawada (IN); Neeraj Kkumar, Pune (IN)

(72) Inventors: SAMRAT JAYPRAKASH PATIL, Pune (IN); Sarat Kumar Konduru, Vijayawada (IN); Neeraj Kkumar, Pune (IN)

(73) Assignee: NVIDIA Corporation, Santa Clara, CA (US)

(21) Appl. No.: 13/602,211

(22) Filed: Sep. 3, 2012

(51) Int. Cl. G06T 15/00

(52) U.S. Cl. 345/419

(57) ABSTRACT

Disclosed are several methods, a device and a system for repositioning a multidimensional virtual environment based on a relative motion of a cephalic member of a human subject. In one embodiment, a method includes analyzing a relative motion of a cephalic member of a human subject. In addition, the method may include calculating a shift parameter based on an analysis of the relative motion and repositioning a multidimensional virtual environment based on the shift parameter such that the multidimensional virtual environment reflects a proportional visual response to the relative motion of the cephalic member of the human subject using a multimedia processor.

### FIELD OF TECHNOLOGY

This disclosure relates generally to an interactive multidimensional stereoscopic technology, in one example embodiment, to a method, device, and/or system of a proportional visual response to a relative motion of a cephalic member of a human subject.

### BACKGROUND

Physical movement of a cephalic member of a human subject (e.g., a human subject's head) may express a set of emotions and thoughts that mimic the desires and wants of the human subject. Furthermore, a perceivable viewing area may shift along with the physical movement of the cephalic member as the position of the human subject's eyes may change.

A multimedia virtual environment (e.g., a video game, a virtual reality environment, or a holographic environment) may permit a human subject to interact with objects and subjects rendered in the multimedia virtual environment. For example, the human subject may be able to control an action of a character in the multimedia virtual environment as the character navigates through a multidimensional space. Such control may be gained by moving a joystick, a gamepad, and/or a computer mouse. Such control may also be gained by a tracking device monitoring the exaggerated motions of the human subject.

For example, the tracking device may be an electronic device such as a camera and/or a motion detector. However, the tracking device may miss a set of subtle movements (e.g., subconscious movement, involuntary movement, and or a reflexive movement) which may express an emotion or desire of the human subject as the human subject interacts with the multimedia virtual environment. As such, the human subject may experience fatigue and/or eye strain because of a lack of responsiveness in the multimedia virtual environment. Furthermore, the user may choose to discontinue interacting with the multimedia virtual environment, thereby resulting in lost revenue for the creator of the multimedia virtual environment.

### SUMMARY

Disclosed are a method, a device and/or a system for repositioning a multidimensional virtual environment based on a relative motion of a cephalic member of a human subject. In one aspect, a method may include analyzing a relative motion of a cephalic member of a human subject. In addition, the method may include calculating a shift parameter based on an analysis of the relative motion and repositioning a multidimensional virtual environment based on the shift parameter such that the multidimensional virtual environment reflects a proportional visual response to the relative motion of the cephalic member of the human subject using a multimedia processor. In this aspect, the multimedia processor may be one of a graphics processing unit, a visual processing unit, and a general purpose graphics processing unit.

The method may include calculating the shift parameter by determining an initial positional location of the cephalic member of the human subject through a tracking device and converting the relative motion to a motion data using the multimedia processor. The method may also include applying a repositioning algorithm to the multidimensional virtual environment based on the shift parameter and repositioning the multidimensional virtual environment based on a result of the repositioning algorithm.

In another aspect, the method may include determining the initial positional location by observing the cephalic member of the human subject through an optical device to capture an image of the cephalic member of the human subject. The method may also include calculating the initial positional location of the cephalic member of the human subject based on an analysis of the image and assessing that the cephalic member of the human subject is located at a particular region of the image through a focal-region algorithm.

The method may also include determining that the relative motion is one of a flexion motion in a forward direction along a sagittal plane of the human subject, an extension motion in a backward direction along the sagittal plane of the human subject, a left lateral motion in a left lateral direction along a coronal plane of the human subject, a right lateral motion in a right lateral direction along the coronal plane of the human subject, and a circumduction motion along a conical trajectory.

In one aspect, the method may include converting the flexion motion to a forward motion data, the extension motion to a backward motion data, the left lateral motion to a left motion data, the right lateral motion to a right motion data, the circumduction motion to a circumduction motion data, and the initial positional location to an initial positional location data using the multimedia processor. The method may calculate a change in a position of the cephalic member of the human subject by analyzing at least one of the forward motion data, the backward motion data, the left motion data, the right motion data, and the circumduction motion data with the initial positional location data using the multimedia processor. The method may also include selecting a multidimensional virtual environment data from a non-volatile storage, where the multidimensional virtual environment data is based on the multidimensional virtual environment displayed to the human subject through a display unit at an instantaneous time of the relative motion, and applying the repositioning algorithm to the multidimensional virtual environment data selected from the non-volatile storage based on at least one of the forward motion data, the backward motion data, the left motion data, the right motion data, and the circumduction motion data when compared against the initial positional location data. The method may also include introducing a repositioned multidimensional virtual environment data to a random access memory.

The method may further comprise detecting the relative motion of the cephalic member of the human subject through the tracking device by sensing an orientation change of a wearable tracker, where the wearable tracker is comprised of a gyroscope component configured to manifest the orientation change which permits the tracking device to determine the relative motion of the cephalic member of the human subject.

The relative motion of the cephalic member of the human subject may be a continuous motion and a perspective of the multidimensional virtual environment may be repositioned continuously and in synchronicity with the continuous motion. The tracking device may be any of a stand-alone web camera, an embedded web camera, and a motion sensing device and the multidimensional virtual environment may be any of a three dimensional virtual environment and a two dimensional virtual environment.

Disclosed is also a data processing device for repositioning a multidimensional virtual environment based on a relative motion of a cephalic member of a human subject. The data processing device may include a non-volatile storage to store a multidimensional virtual environment, a multimedia processor to calculate a shift parameter based on an analysis of a relative motion of a cephalic member of a human subject, and a random access memory to maintain the multidimensional virtual environment repositioned by the multimedia processor based on the shift parameter such that the multidimensional virtual environment repositioned by the multimedia processor reflects a proportional visual response to the relative motion of the cephalic member of the human subject.

In one aspect, the multimedia processor may be configured to determine that the relative motion is at least one of a flexion motion in a forward direction along a sagittal plane of the human subject, an extension motion in a backward direction along the sagittal plane of the human subject, a left lateral motion in a left lateral direction along a coronal plane of the human subject, a right lateral motion in a right lateral direction along the coronal plane of the human subject, and a circumduction motion along a conical trajectory.

The multimedia processor may be configured to determine an initial positional location of the cephalic member of the cephalic member of the human subject through a tracking device. The multimedia process may also convert the relative motion to a motion data using the multimedia processor, to apply a repositioning algorithm to the multidimensional virtual environment based on the shift parameter, and to reposition the multidimensional virtual environment based on a result of the repositioning algorithm.

The multimedia processor may be configured to operate in conjunction with an optical device to determine the initial positional location of the cephalic member of the human subject based on an analysis of an image and to assess that the cephalic member of the human subject is located at a particular region of the image through a focal-region algorithm. The multimedia processor of the data processing device may be any of a graphics processing unit, a visual processing unit, and a general purpose graphics processing unit.

The multimedia processor may be configured to convert a flexion motion to a forward motion data, an extension motion to a backward motion data, a left lateral motion to a left motion data, a right lateral motion to a right motion data, a circumduction motion to a circumduction motion data, and an initial positional location to an initial positional location data using the multimedia. The multimedia processor may calculate a change in a position of the cephalic member of the human subject by analyzing at least one of the forward motion data, the backward motion data, the left motion data, the right motion data, and the circumduction motion data with the initial positional location data using the multimedia processor. The multimedia processor may also select a multidimensional virtual environment data from the non-volatile storage, where the multidimensional virtual environment data is based on the multidimensional virtual environment displayed to the human subject through a display unit at an instantaneous time of the relative motion.

The multimedia processor may also apply a repositioning algorithm to the multidimensional virtual environment data selected from the non-volatile storage based on at least one of the forward motion data, the backward motion data, the left motion data, the right motion data, and the circumduction motion data when compared against the initial positional location data, and introduce a repositioned multidimensional virtual environment data to the random access memory of the data processing device.

Disclosed is also a cephalic response system for repositioning a multidimensional virtual environment based on a relative motion of a cephalic member of a human subject. In one aspect, the cephalic response system may include a tracking device to detect a relative motion of a cephalic member of a human subject, an optical device to determine an initial positional location of the cephalic member of the human subject, a data processing device to calculate a shift parameter based on an analysis of the relative motion of the cephalic member of the human subject and to reposition a multidimensional virtual environment based on the shift parameter using a multimedia processor such that the multidimensional virtual environment reflects a proportional visual response to the relative motion of the cephalic member of the human subject, and a wearable tracker to manifest an orientation change which permits the data processing device to detect the relative motion of the cephalic member of the human subject.

The cephalic response system may also include a gyroscope component embedded in the wearable tracker and configured to manifest the orientation change which permits the data processing device to determine the relative motion of the cephalic member of the human subject.

The data processing device may be configured to determine the initial positional location of the cephalic member of the human subject through the tracking device. The data processing device may operate in conjunction with the optical device to determine the initial positional location of the cephalic member of the human subject based on an analysis of an image captured by the optical device and to assess that the cephalic member of the human subject is located at a particular region of the image through a focal-region algorithm

The data processing device of the cephalic response system may convert the relative motion to a motion data using the multimedia processor and may apply a repositioning algorithm to the multidimensional virtual environment based on the shift parameter. The data processing device may also reposition the multidimensional virtual environment based on a result of the repositioning algorithm.

The methods disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a frontal view of a cephalic response system tracking a relative motion of a cephalic member of a human subject, according to one embodiment.

FIGS. 2A, 2B, and 2C are perspective views of anatomical planes of a cephalic member of a human subject, according to one embodiment.

FIGS. 3A and 3B are side and frontal views, respectively, of relative motions of a cephalic member of a human subject, according to one embodiment.

FIGS. 4A and 4B are before and after views, respectively, of a repositioned multidimensional virtual environment as a result of a motion of a cephalic member of a human subject, according to one embodiment.

FIGS. 5A and 5B are before and after views, respectively, of a repositioned multidimensional virtual environment as a result of a motion of a cephalic member of a human subject, according to one embodiment.

FIG. 6 is process flow diagram of a method of repositioning a multidimensional virtual environment, according to one embodiment.

FIG. 7 is process flow diagram of a method of repositioning a multidimensional virtual environment based on a relative motion of a cephalic member of a human subject, according to one embodiment.

FIG. 8 is a process flow diagram of a method of repositioning a multidimensional virtual environment based on a relative motion of a cephalic member of a human subject and a shift parameter, according to one embodiment.

FIG. 9 is a schematic of several tracking devices interacting with a wearable tracker through a network, according to one embodiment.

FIGS. 10A and 10B are regular and focused views, respectively, of a wearable tracker and its embedded gyroscope component, respectively, according to one embodiment.

FIG. 11 is a schematic of a data processing device, according to one embodiment.

FIG. 12 is a schematic of a cephalic response system, according to one embodiment.

Other features of the present embodiments will be apparent from the accompanying drawings and from the detailed description that follows.

### DETAILED DESCRIPTION

Example embodiments, as described below, may be used to provide a method, a device and/or a system for repositioning a multidimensional virtual environment based on a relative motion of a cephalic member of a human subject. Although the present embodiments have been described with reference to specific example embodiments, it will be evident that various modifications and changes may be made to these embodiments without departing from the broader spirit and scope of the various embodiments.

In this description, the terms “relative motion,” “flexion motion,” “extension motion,” “left lateral motion,” “right lateral motion,” and “circumduction motion” are all used to refer to motions of a cephalic member of a human subject (e.g., a head of a human), according to one or more embodiments.

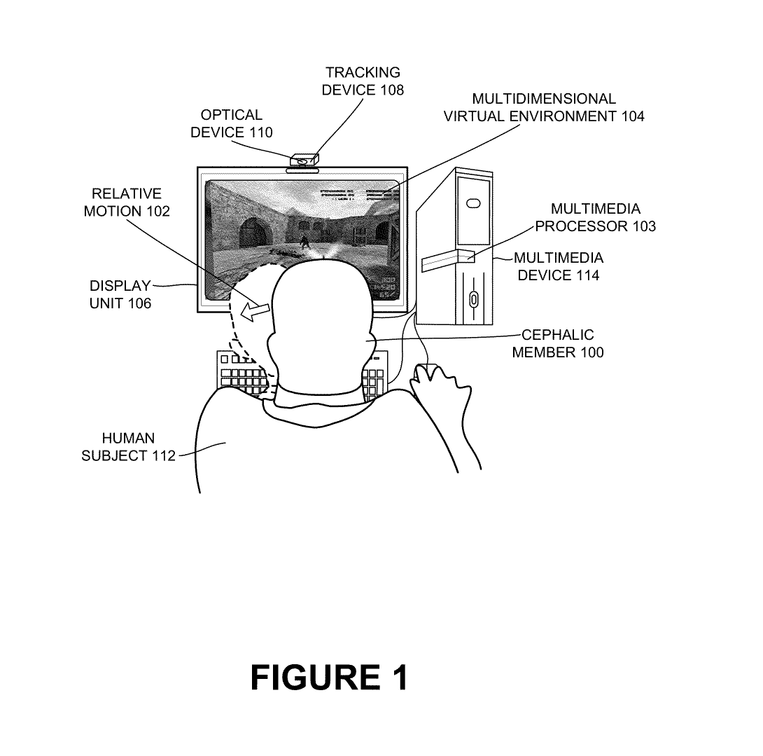

Reference is now made to FIG. 1, which shows a cephalic member 100 of a human subject 112 and the relative motion 102 of the cephalic member 100 being tracked by a tracking device 108, according to one or more embodiments. In one embodiment, the tracking device 108 may be communicatively coupled with a multimedia device 114 which may contain a multimedia processor 103. In another embodiment, the tracking device 108 is separate from the multimedia device 114 comprising the multimedia processor 103 and communicates with the multimedia device 144 through a wired or wireless network. In yet another embodiment, the tracking device 108 may be at least one of astereoscopic head-tracking device and a gaming motion sensor device (e.g., Microsoft®'s Kinect® motion sensor, a Sony® Eyetoy® and/or Sony® Move® sensor, and a Nintendo® Wii® sensor).

In one embodiment, the multimedia processor 103 is one of a graphics processing unit, a visual processing unit, and a general purpose graphics processing unit (e.g., NVIDIA®'s GeForce® graphics card or NVIDIA®'s Quadro® graphics card).The multimedia processor 103 may analyze the relative motion 102 of the cephalic member 100 of the human subject 112 and may also calculate a shift parameter based on the analysis of the relative motion 102. In one embodiment, the multimedia processor 103 may then reposition a multidimensional virtual environment 104 based on the shift parameter such that the multidimensional virtual environment 104 reflects a proportional visual response to the relative motion 102 of the cephalic member 100 of the human subject 112 using the multimedia processor 103. In one embodiment, the multidimensional virtual environment 104 is rendered through a display unit 106. The display unit 106 may be any of a flat panel display (e.g., liquid crystal, active matrix, or plasma), a video projection display, a monitor display, and/or a screen display.

The multimedia processor 103 may then reposition a multidimensional virtual environment 104 based on the shift parameter such that the multidimensional virtual environment 104 reflects a proportional visual response to the relative motion 102 of the cephalic member 100.In one embodiment, the multidimensional virtual environment 104 repositioned may be an NVIDIA® 3D Vision® ready multidimensional game such as Max Payne 3®, Battlefield 3®, Call of Duty: Black Ops®, and/or Counter-Strike®. In another embodiment, the multidimensional virtual environment 104 repositioned may be a computer assisted design (CAD) environment or a medical imaging environment.

In one embodiment, the shift parameter may be calculated by determining an initial positional location of the cephalic member 100 through the tracking device 108 and converting the relative motion 102 of the cephalic motion 100 to a motion data using the multimedia processor 103. The multimedia processor 103 may be communicatively coupled to the tracking device 108 or may receive data information from the tracking device 108 through a wired and/or wireless network. The multimedia processor 103 may then apply a repositioning algorithm to the multidimensional virtual environment 104 based on the shift parameter. In one embodiment, the repositioning algorithm may be a matrix transformation algorithm or a linear transformation algorithm. The multimedia processor 103 may then reposition the multidimensional virtual environment based on a result of the repositioning algorithm.

In one embodiment, the initial positional location may be determined by observing the cephalic member 100 of the human subject 112 using an optical device 110 to capture an image of the cephalic member 100. This image may then be stored in a volatile memory (e.g., a random access memory) and the multimedia processor 103 may then calculate the initial positional location of the cephalic member 100 of the human subject based on an analysis of the image captured. In a further embodiment, the multimedia processor 103 may then assess that the cephalic member 100 of the human subject 112 is located at a particular region of the image through a focal-region algorithm.

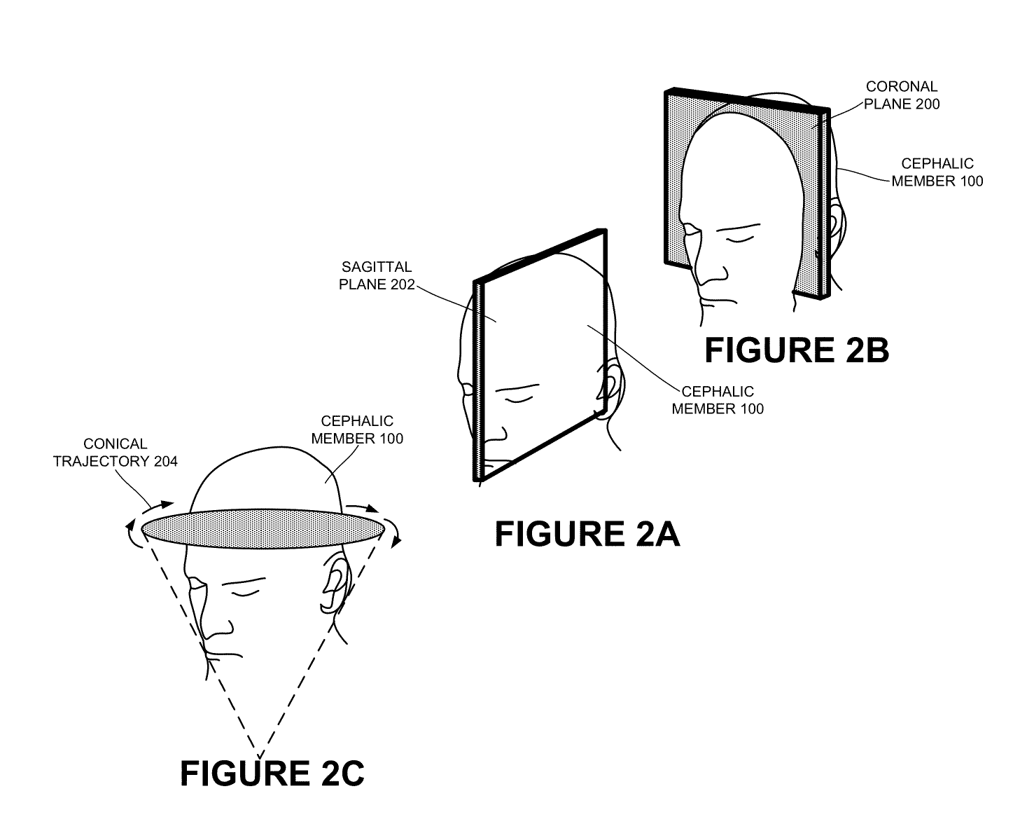

Reference is now made to FIGS. 2A, 2B, and 2C, which are perspective views of anatomical planes of the cephalic member 100 of the human subject 112, according to one embodiment. FIG. 2A shows a sagittal plane 202 of the cephalic member 100. FIG. 2B shows a coronal plane 200 of the cephalic member 100. FIG. 2C shows a conical trajectory 204 that the cephalic member 100 can move along, in one example embodiment.

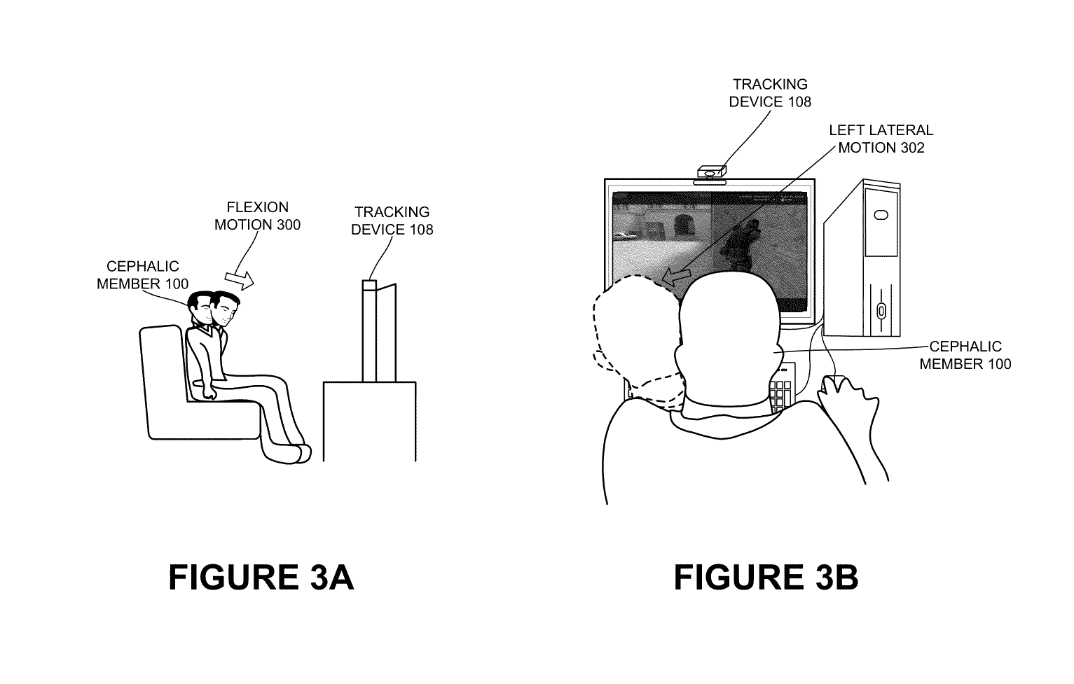

Reference is now made to FIGS. 3A and 3B, which are side and frontal views, respectively, of relative motions of the cephalic member 100 of the human subject 112, according to one embodiment. In one example embodiment, the cephalic member 100 of the human subject 112 is engaging in a flexion motion 300 (see FIG. 3A). In another example embodiment, the cephalic member 100 is moving in a left lateral motion 302 (see FIG. 3B).

In one example embodiment, the tracking device 108 may determine that the relative motion 102 is at least one of: the previously described flexion motion 300 in a forward direction along the sagittal plane 202 of the human subject 112, an extension motion in a backward direction along the sagittal plane 202 of the human subject 112, the left lateral motion 302 in a left lateral direction along the coronal plane 200 of the human subject 112, a right lateral motion in a right lateral direction along the coronal plane 200 of the human subject 112, and/or a circumduction motion along the conical trajectory 204.The relative motion 102 may be any of the previously described motions or a combination of the previously described motions. For example, the relative motion 102 may comprise the flexion motion 300 followed by the left lateral motion 302. Addition, the relative motion 102 may comprise the right lateral motion followed by the extension motion.

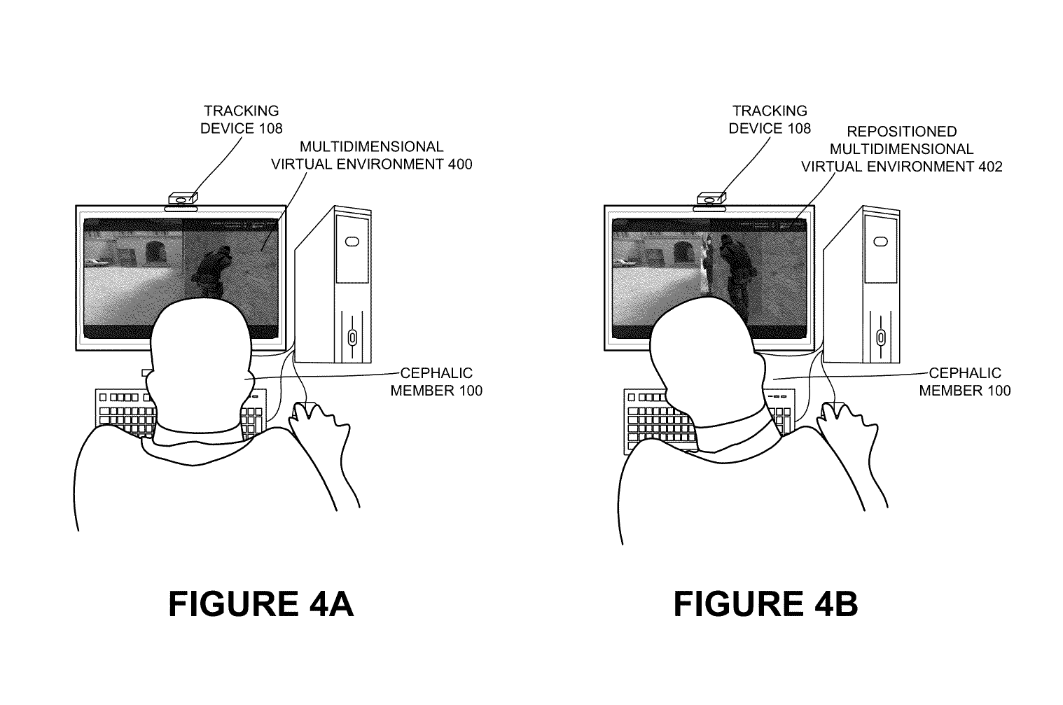

Reference is now made to FIGS. 4A and 4B, which are before and after views, respectively, of a repositioned multidimensional virtual environment 402 as a result of the relative motion 102 of the cephalic member 100 of the human subject 112, according to one embodiment. In one embodiment, the tracking device 108, in conjunction with the multimedia processor 103, may convert the relative motion 102 into a motion data (e.g., the flexion motion 300 into a forward motion data, the extension motion into a backward motion data, the left lateral motion 302 into a left motion data, the right lateral motion into a right motion data, and/or the circumduction motion into a circumduction motion data). The multimedia processor 103 may also convert the initial positional location of the cephalic member 100 into an initial positional location data. The multimedia processor 103 may also calculate a change in a position of the cephalic member 100 of the human subject 112 based on at least one of the forward motion data, the backward motion data, the left motion data, the right motion data, and the circumduction motion data with the initial positional data.

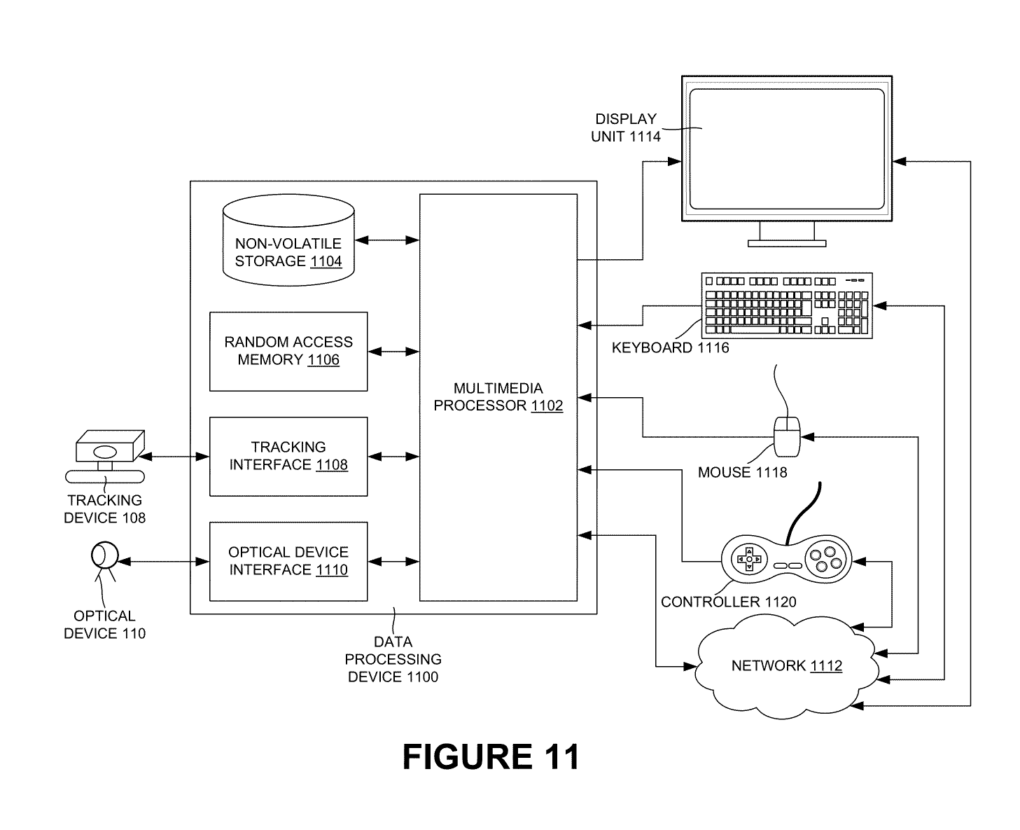

In one embodiment, the multimedia processor 103 selects a multidimensional virtual environment data from a non-volatile storage (see FIG. 11) where the multidimensional virtual environment data is based on a multidimensional virtual environment displayed to the human subject 112 through a display unit at an instantaneous time of the relative motion 102.

In one embodiment, the multimedia processor may apply a repositioning algorithm to the multidimensional virtual environment data selected from the non-volatile storage (see FIG. 11) based on at least one of the forward motion data, the backward motion data, the left motion data, the right motion data, and the circumduction motion data when compared against the initial positional location data. The multimedia processor may then introduce a repositioned multidimensional virtual environment data to a random access memory (see FIG. 11). In one embodiment, the repositioning algorithm may be a matrix transformation algorithm or a linear transformation algorithm.

A central processing unit (CPU) and/or the multimedia processor 103 of a multimedia device (e.g., a computer, a gaming system, a multimedia system) may then retrieve this data from the random access memory (see FIG. 11) and transform the repositioned multidimensional virtual environment data to a repositioned multidimensional virtual environment 402 that may be displayed to a human subject viewing the display unit.

In one embodiment, the multidimensional virtual environment 400 is the multidimensional virtual environment 104 first introduced in FIG. 1. In another embodiment, the multidimensional virtual environment is a virtual gaming environment. In yet another embodiment, the multidimensional virtual environment is a computer assisted design (CAD) environment, and in an additional embodiment, the multidimensional virtual environment is a multidimensional medical imaging environment.

For example, as can be seen in FIGS. 4A and 4B, the multidimensional virtual environment 400 is a virtual gaming environment (e.g., an environment from the multi-player role playing game Counter-Strike®). In one embodiment, the human subject 112 is a gaming enthusiast. In this embodiment, the gaming enthusiast is viewing a scene from the multidimensional virtual environment 400 where the player's field of view is hindered by the corner of a wall. In this same embodiment, the gaming enthusiast may initiate a left lateral motion (e.g., the left lateral motion 302 of FIG. 3B) of his head and see another player hidden behind the corner. This new field of view exposing the hidden player is one example of the repositioned multidimensional virtual environment 402, according to one example embodiment. In this embodiment, the gaming enthusiast did not use a traditional input device (e.g., a joystick, a mouse, a keyboard, or a game controller) to initiate the repositioning of the multidimensional virtual environment 400.

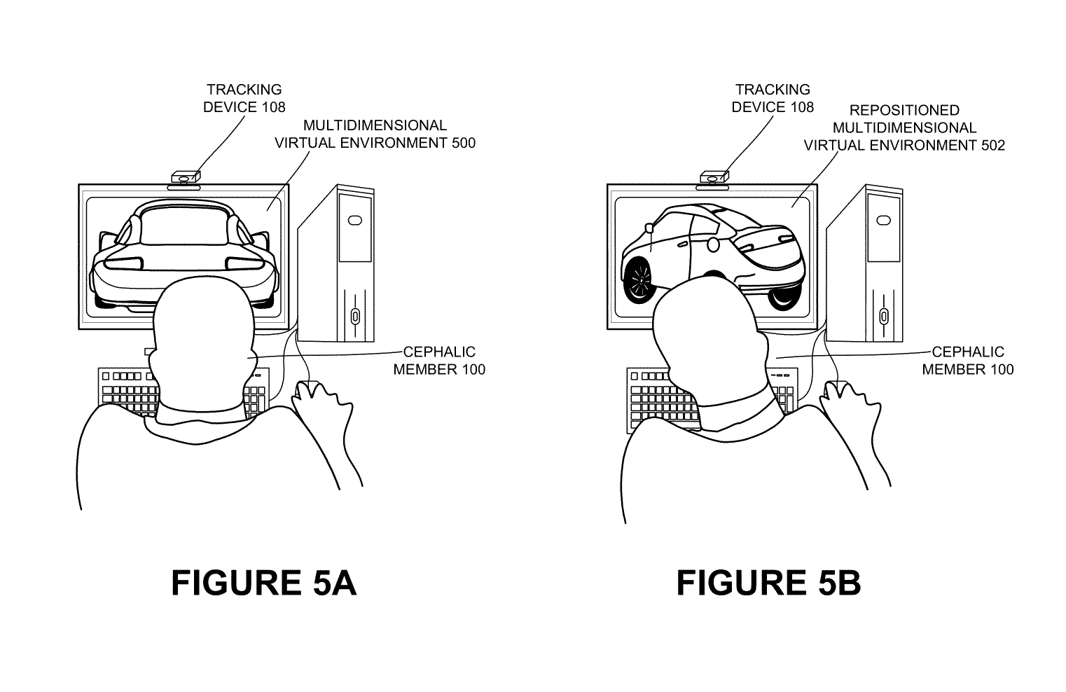

Reference is now made to FIGS. 5A and 5B, which are before and after views, respectively, of a repositioned multidimensional virtual environment 502 as a result of the relative motion 102 of the cephalic member 100 of the human subject 112, according to one embodiment. The tracking device 108, in conjunction with the multimedia processor 103, may convert the relative motion 102 into a motion data (e.g., the flexion motion 300 into a forward motion data, the extension motion into a backward motion data, the left lateral motion 302 into a left motion data, the right lateral motion into a right motion data, and/or the circumduction motion into a circumduction motion data). The multimedia processor 103 may also convert the initial positional location of the cephalic member 100 into an initial positional location data. The multimedia processor 103 may also calculate a change in a position of the cephalic member 100 of the human subject 112 based on an analysis of at least one of the forward motion data, the backward motion data, the left motion data, the right motion data, and the circumduction motion data with the initial positional data.

In one embodiment, the multimedia processor 103 may select a multidimensional virtual environment data from a non-volatile storage (see FIG. 11) where the multidimensional virtual environment data is based on a multidimensional virtual environment displayed to the human subject 112 through a display unit at an instantaneous time of the relative motion 102.

In one embodiment, the multimedia processor may apply a repositioning algorithm to the multidimensional virtual environment data selected from the non-volatile storage (see FIG. 11) based on at least one of the forward motion data, the backward motion data, the left motion data, the right motion data, and the circumduction motion data when compared against the initial positional location data. The multimedia processor may then introduce a repositioned multidimensional virtual environment data to a random access memory (see FIG. 11). A central processing unit (CPU) and/or a multimedia processor of a multimedia device (e.g., a computer, a gaming system, a multimedia system) may then retrieve this data from the random access memory (see FIG. 11) and transform the repositioned multidimensional virtual environment data to a repositioned multidimensional virtual environment 402 that may be displayed to a human subject viewing the display unit.

For example, as can be seen in FIGS. 5A and 5B, the multidimensional virtual environment 500 is a computer assisted design environment (e.g., a computer assisted design of an automobile). In one embodiment, the human subject 112 is a mechanical engineer responsible for designing an automobile. In this embodiment, the mechanical engineer is viewing a car design from a particular vantage point. In this same embodiment, the mechanical engineer may initiate a left lateral motion (e.g., the left lateral motion 302 of FIG. 3B) of his head and see the design of the automobile from another angle. This new perspective of the automobile is one example of the repositioned multidimensional virtual environment 502, according to one example embodiment. In this embodiment, the mechanical engineer did not use a traditional input device (e.g., a joystick, a mouse, a keyboard, or a game controller) to initiate the repositioning of the multidimensional virtual environment 500.

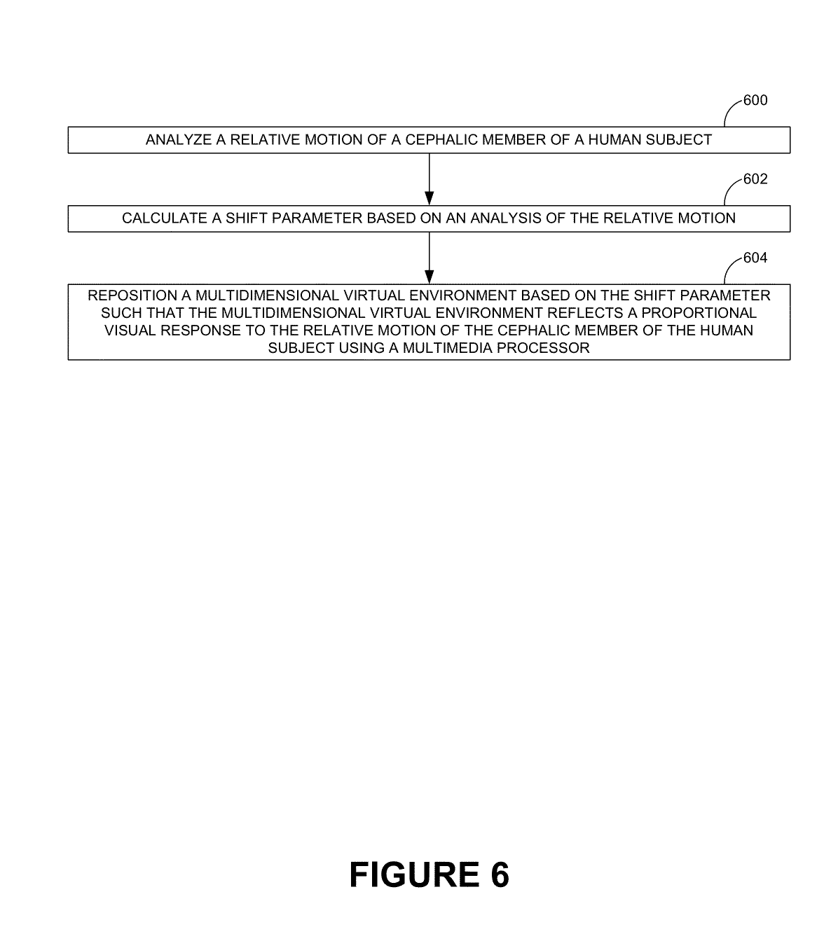

Reference is now made to FIG. 6 which is process flow diagram of a method of repositioning the multidimensional virtual environment 104, according to one embodiment. In operation 600, the multimedia processor 103 may analyze the relative motion 102 of the cephalic member 100 of the human subject 112. The multimedia processor 103 may then calculate a shift parameter based on an analysis of the relative motion 102 in operation 602. In operation 604, the multimedia processor may reposition the multidimensional virtual environment 104 based on the shift parameter such that the multidimensional virtual environment 104 reflects a proportional visual response to the relative motion 102 of the cephalic member 100 of the human subject 112.

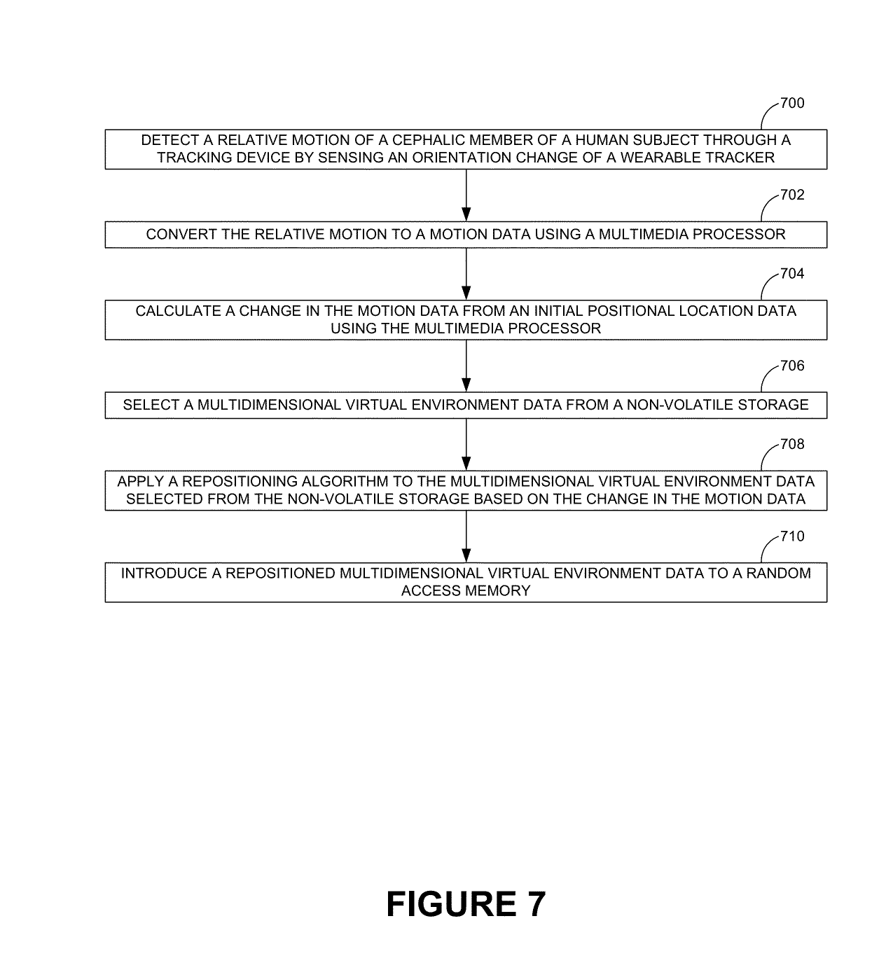

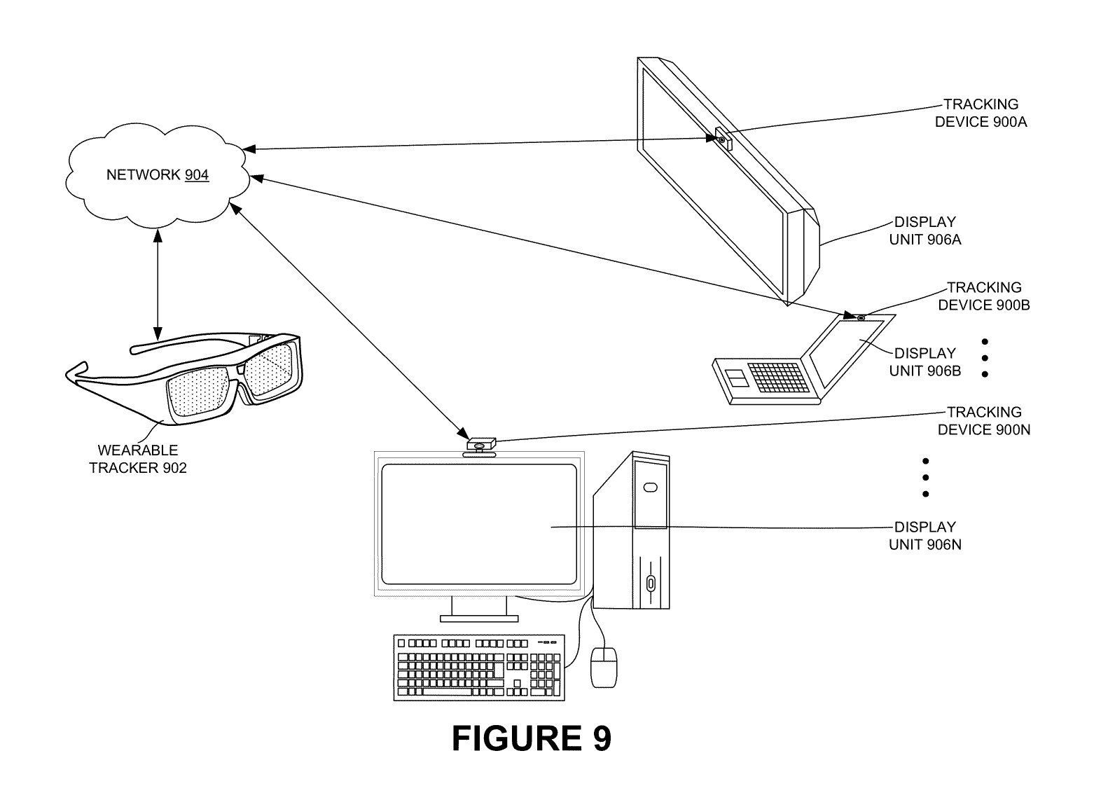

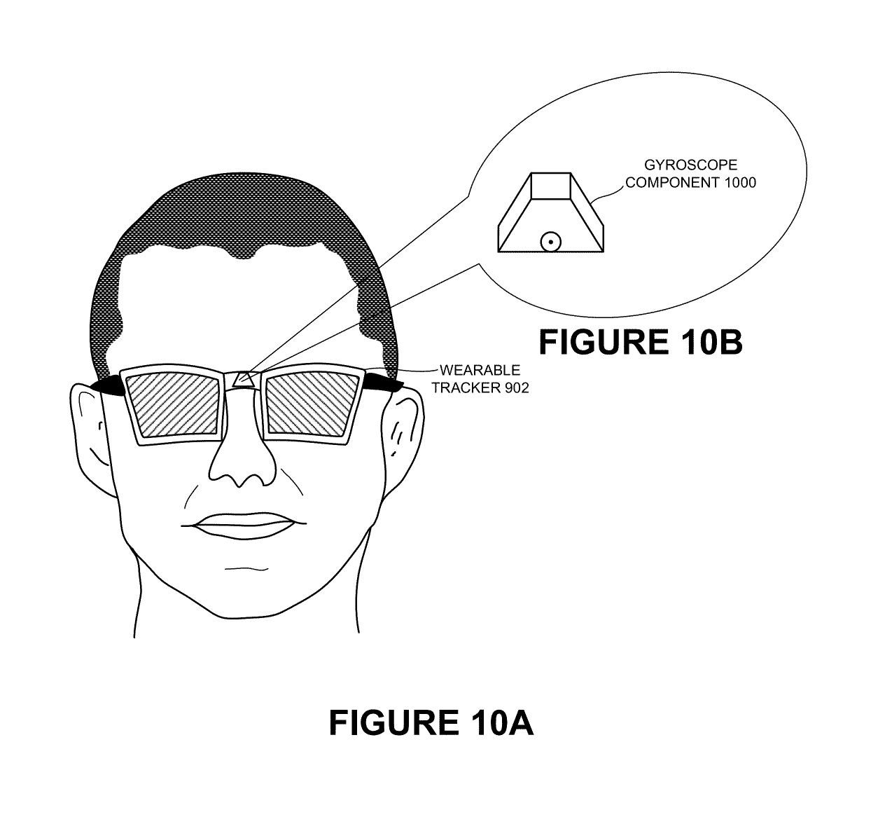

Reference is now made to FIG. 7 which is a process flow diagram of a method of repositioning the multidimensional virtual environment 104 based on the relative motion 102 of the cephalic member 100 of the human subject 112, according to one embodiment. In process 700, the tracking device 108 may detect the relative motion 102 of the cephalic member 100 of the human subject 112 by sensing an orientation change of a wearable tracker (see FIG. 9 and FIG. 10A). In process 702, the multimedia processor 103 may convert the relative motion 102 to a motion data. In another embodiment, the multimedia processor 103may also convert the initial positional location to an initial positional location data. In process 704, the multimedia processor 103 may calculate a change in a position of the cephalic member 100 of the human subject 112 based on an analysis of the motion data from the initial positional location data. In process 706, the multimedia processor may select the multidimensional virtual environment data from a non-volatile storage, wherein the multidimensional virtual environment data is based on the multidimensional virtual environment 104 displayed to the human subject 112 through a display unit 106 at an instantaneous time of the relative motion.

In process 708, the multimedia processor may apply a repositioning algorithm to the multidimensional virtual environment data selected from the non-volatile storage based on the change in the motion data. In one embodiment, the repositioning algorithm may be a matrix transformation algorithm or a linear transformation algorithm. In process 710, the multimedia processor may introduce a repositioned multidimensional virtual environment data to a random access memory of a multimedia device and/or a general computing device.

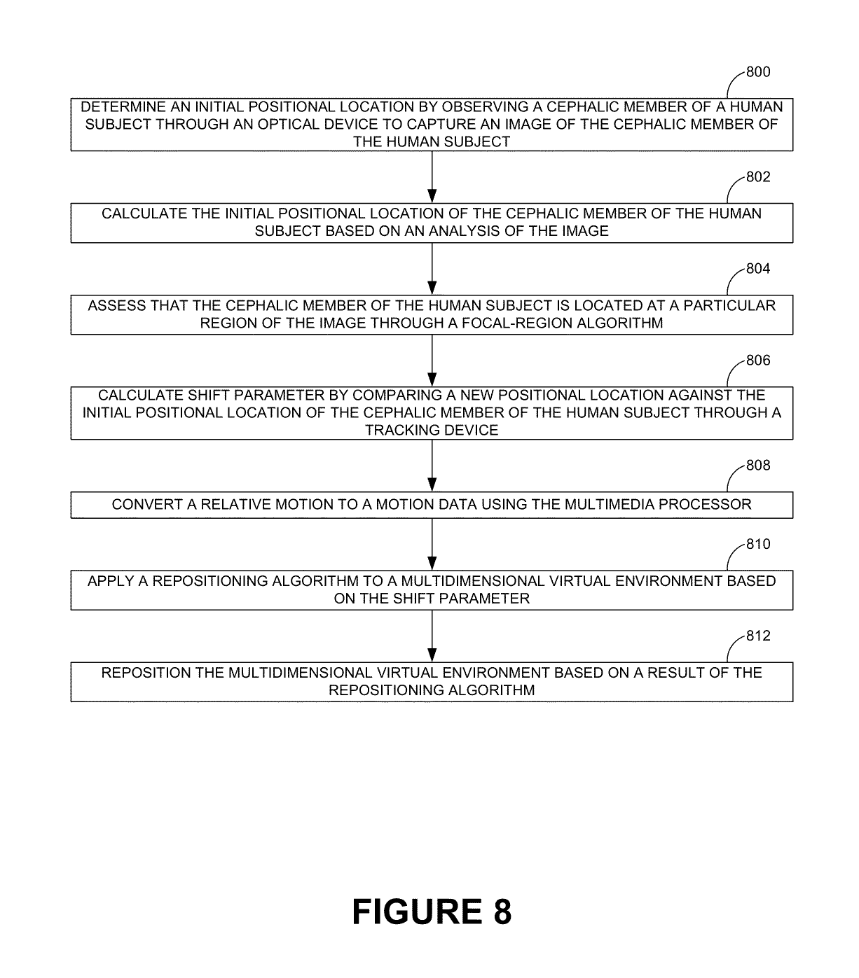

Reference is now made to FIG. 8 which is a process flow diagram of a method of repositioning the multidimensional virtual environment 104 based on a calculation of the shift parameter, according to one embodiment. In process 800, the multimedia processor 103 may determine the initial positional location by observing the cephalic member 100 of the human subject 112 through the optical device 110 to capture an image of the cephalic member 100 of the human subject 112. In process 802, the multimedia processor 103 may calculate the initial positional location of the cephalic member 100 of the human subject 112 based on an analysis of the image.

In process 804, the multimedia processor 103 may then assess that the cephalic member 100 of the human subject 112 is located at a particular region of the image through a focal-region algorithm. In process 806, the multimedia processor 103 may then calculate and obtain the shift parameter by comparing the new positional location against the initial positional location of the cephalic member 100 of the human subject 112. The multimedia processor 103 may be embedded in the tracking device 108 or may be communicatively coupled to the tracking device 108.

In operation 808, the multimedia processor may convert the relative motion 102 to a motion data. In operation 810, the multimedia processor may apply the repositioning algorithm to the multidimensional virtual environment data selected from the non-volatile storage based on the shift parameter previously described. In operation 812, the multimedia processor may reposition the multidimensional virtual environment 104 based on a result of the repositioning algorithm.

Reference is now made to FIG. 9 which is a schematic of a plurality of tracking devices 900A-900N interacting with a wearable tracker 902 through a network 904, according to one embodiment. In one embodiment, the tracking device 900A may be placed on a display unit 906A (e.g. a television) and may be separate from the display unit 906A. In another embodiment, the tracking device 900B may be embedded into and/or coupled to the display unit 906B of a laptop computer. In yet another embodiment, the tracking device 900N may be affixed to the display unit 906N of a computing device (e.g., a desktop computer monitor).

In one embodiment, the plurality of tracking devices 900A-900N acts as a receiver for the wearable tracker 902. In another embodiment, the tracking devices 900A-900N may be stereoscopic head-tracking devices and gaming motion sensor devices (e.g., Microsoft®'s Kinect® motion sensor, a Sony® Eyetoy® and/or Sony® Move® sensor, and a Nintendo® Wii® sensor).

In yet another embodiment, the receiver may be separate from the plurality of tracking devices 900A-900N and may be communicatively coupled to the plurality of tracking devices 900A-900N. In one embodiment, a data signal from the wearable tracker 902 may be received by at least one of the plurality of tracking devices 900A-900N. In one embodiment, the data signal may be transmitted from the wearable tracker 902 to at least of the plurality of tracking devices 900A-900N through a network 904. The network 904 may comprise at least one of a wireless communication network, an optical or infrared link, and a radio frequency link (e.g., Bluetooth®). The wireless communication network may be a local, proprietary network (e.g., an intranet) and/or may be a part of a larger wide-area network. The wireless communication network may also be a local area network (LAN), which may be communicatively coupled to a wide area network (WAN) such as the Internet.

In one embodiment, any one of the plurality of tracking devices 900A-900N may comprise at least one of a facial recognition camera, a depth sensor, an infrared projector, a color VGA video camera, and a monochrome CMOS sensor.

Reference is now made to FIGS. 10A and 10B which are regular and focused views, respectively, of the wearable tracker 902 and a gyroscope component 1000 embedded in the wearable tracker 902, respectively, according to one embodiment. In one example embodiment, the wearable tracker 902 may be a set of glasses worn by the human subject 112 on the human subject 112's cephalic member 100. In another embodiment, the wearable tracker 902 may be positioned on the cephalic member 100 of the human subject 112 as an attachable token. In yet another embodiment, the wearable tracker 902 may be affixed to the cephalic member 100 of the human subject 112 through an adhesive. In an additional embodiment, the wearable tracker 902 may be affixed to the cephalic member 100 of the human subject 112 through a clip mechanism.

In one embodiment, the gyroscope component 1000 may be embedded in the bridge of the wearable tracker 902. In one example embodiment, the wearable tracker 902 may be a set of 3D compatible eyewear (e.g., NVIDIA®'s 3D Vision Ready® glasses) worn on the cephalic member 100.

In one embodiment, the gyroscope component 1000 may comprise a ring laser and microelectromechanical systems (MEMS) technology. In another embodiment, the gyroscope component 1000 may comprise at least one of a motor, an electronic circuit card, a gimbal, and a gimbal frame. In another embodiment, the gyroscope component 1000 may comprise piezoelectric technology.

Reference is now made to FIG. 11 which is a schematic illustration of a data processing device 1100, according to one embodiment. In one embodiment, the data processing device 1100 may comprise a non-volatile storage 1104 to store the multidimensional virtual environment 104; a multimedia processor 1102 to calculate a shift parameter based on an analysis of the relative motion 102 of the cephalic member 100 of the human subject 112. In one embodiment, the data processing device 1100 containing the multimedia processor 1102may be communicatively coupled to the tracking device 108 through a tracking interface 1108. In another embodiment, the data processing device 1100 containing the multimedia processor 1102 may be embedded in the tracking device 108.

In one embodiment, the multimedia processor 1102 in the data processing device 1100 may work in conjunction with the tracking device 108 to determine that the relative motion 102 is at least one of a flexion motion in a forward direction along the sagittal plane 202 of the human subject 112, an extension motion in a backward direction along the sagittal plane 202 of the human subject 112, a left lateral motion 302 in a left lateral direction along the coronal plane 200 of the human subject 112, a right lateral motion in a right lateral direction along the coronal plane 200 of the human subject 112, and a circumduction motion along the conical trajectory 204.

In one embodiment, the multimedia processor 1102 is the multimedia processor 103 described in FIG. 1. In this embodiment, the multimedia processor 1102 may be at least one of a graphics processing unit, a visual processing unit, and a general purpose graphics processing unit (e.g., NVIDIA®'s GeForce® graphics card or NVIDIA®'s Quadro® graphics card). In another embodiment, the data processing device 1100 may comprise a random access memory 1106 to maintain the multidimensional virtual environment 104 repositioned by the multimedia processor 1102 based on the shift parameter such that the multidimensional virtual environment 104 repositioned by the multimedia processor 1102 reflects a proportional visual response to the relative motion 102 of the cephalic member 100 of the human subject 112.

In one embodiment, the multimedia processor 1102may be configured to determine an initial positional location of the cephalic member 100 of the cephalic member 100 of the human subject 112 through the tracking device 108 via the tracking interface 1108. The multimedia processor 1102 may then convert the relative motion 102 to a motion data and apply a repositioning algorithm to the multidimensional virtual environment 104 based on the shift parameter. The multimedia processor 1102 may also reposition the multidimensional virtual environment 104 based on a result of the repositioning algorithm. In one embodiment, the repositioning algorithm may be a matrix transformation algorithm or a linear transformation algorithm.

In another embodiment, the multimedia processor 1102 may be configured to operate in conjunction with the optical device 110 through the optical device interface 1110 to determine the initial positional location of the cephalic member 100 of the human subject 112. This determination can be made based on an analysis of an image captured by the optical device 110. The optical device 110 may be an optical component of a camera system such as a web or video camera. The optical device 110 may then transmit the captured image to the multimedia processor 1102. The captured image transmitted may show that the cephalic member 100 is located at a particular region of the captured image. The multimedia processor 1102 may also determine that the cephalic member 100 is located in a particular region based on a focal-region algorithm applied to at least one of the images and/or image data transmitted to the multimedia processor 1102. An initial positional location of the cephalic member 100 may be determined using the system and/or method previously described. The analysis of the image captured may comprise analyzing the actual image captured or metadata concerning the image. In one embodiment, the multimedia processor 1102 may further assess the initial positional location of the cephalic member 100 of the human subject 112 by comparing a series of images captured by the optical device 110.

In one embodiment, at least one of the tracking device 108 and the optical device 110 may detect the relative motion 102 of the human subject 112. In this embodiment, the tracking device 108 may track the motion of the wearable tracker 902. In this instance, the wearable tracker may also contain a gyroscope component 1000. In another embodiment, at least one of the tracking device 108 and the optical device 110 may detect the relative motion 102 by tracking the eyes of the human subject 112 through a series of images captured by at least one of the tracking device 108 and the optical device 110.

The initial positional location may be determined using the system and/or method previously described with at least one of the optical device 110 and/or the tracking device 108 comprising an embedded form of the optical device 110 located in the tracking device 108. The tracking device 108 and/or the optical device 110 may detect at least one of the flexion motion 300, the extension motion, the left lateral motion, the right lateral motion, and the circumduction motion by comparing an image of the final positional location of the cephalic member 100 of the human subject 112 against the initial positional location. The multimedia processor 1102 may receive information from at least one of the tracking device 108 and the optical device 110 and convert at least one of the flexion motion 300 to a forward motion data, the extension motion to a backward motion data, the left lateral motion 302 to a left motion data, the right lateral motion to a right motion data, the circumduction motion to a circumduction motion data, and the initial positional location to an initial positional location data. The multimedia processor 1102 may then calculate a change in the position of the cephalic member 100 by analyzing the forward motion data, the backward motion data, the left motion data, the right motion data, and the circumduction motion data and comparing such data against the initial positional location data.

In one embodiment, the multimedia processor 1102 may select a multidimensional virtual environment data from the non-volatile storage 1104, wherein the multidimensional virtual environment data is based on the multidimensional virtual environment 104 displayed to the human subject 112 through the display unit 1114 at an instantaneous time of the relative motion 102. The multimedia processor 1102 may then apply a repositioning algorithm to the multidimensional virtual environment data selected from the non-volatile storage 1104 based on least one of the forward motion data, the backward motion data, the left motion data, the right motion data, and the circumduction motion data when compared against the initial positional location data.

The multimedia processor 1102 may then introduce a repositioned multidimensional virtual environment 104 data to a random access memory 1106 of the data processing device 1100.

In one embodiment, the multimedia processor 1102 may incorporate an input data received from at least one of a keyboard 1116, a mouse 1118, and a controller 1120. The data processing device 1100 may be communicatively coupled to at least one of the keyboard 1116, the mouse 1118, or the controller 1120. In another embodiment, the data processing device 1100 may receive a signal data from at least one of the keyboard 1116, the mouse 1118, and the controller 1120 through a network 1112. In one embodiment, the network 1112 is the network 904 described in FIG. 9. In another embodiment, the network 1112 may comprise at least one of a wireless communication network, an optical or infrared link, and a radio frequency link (e.g., Bluetooth®). The wireless communication network may be a local, proprietary network (e.g., an intranet) and/or may be a part of a larger wide-area network. In one embodiment, the multimedia processor 1102 may process the relative motion data as an offset data to the signal data received from at least one of the keyboard 1116, the mouse 1118, and the controller 1120. In another embodiment, the signal data (e.g., the input) received from at least one of the keyboard 1116, the mouse 1118, and the controller 1120 may be processed as an offset data of the relative motion data. The multidimensional virtual environment 104 may be repositioned to a greater extent when additional inputs (e.g., from a mouse, a keyboard, a controller, etc.) are processed by the multimedia processor 1102 in addition to the repositioning caused by the relative motion 102.

In one embodiment, the relative motion 102 of the cephalic member 100 of the human subject 112may be a continuous motion and a perspective of the multidimensional virtual environment 104may be repositioned continuously and in synchronicity with the continuous motion. In one or more embodiments, the multidimensional virtual environment 104may comprise at least a three dimensional virtual environment and a two dimensional virtual environment. In one embodiment, the three dimensional virtual environment may be generated through 3D compatible eyewear (e.g., NVIDIA®'s 3D Vision Ready® glasses). For example, a three dimensional virtual environment may be enhanced by a repositioning of the three dimensional virtual environment as a result of the relative motion 102 of the cephalic member 100 such that the human subject 112 feels like he or she is inside the three dimensional virtual environment.

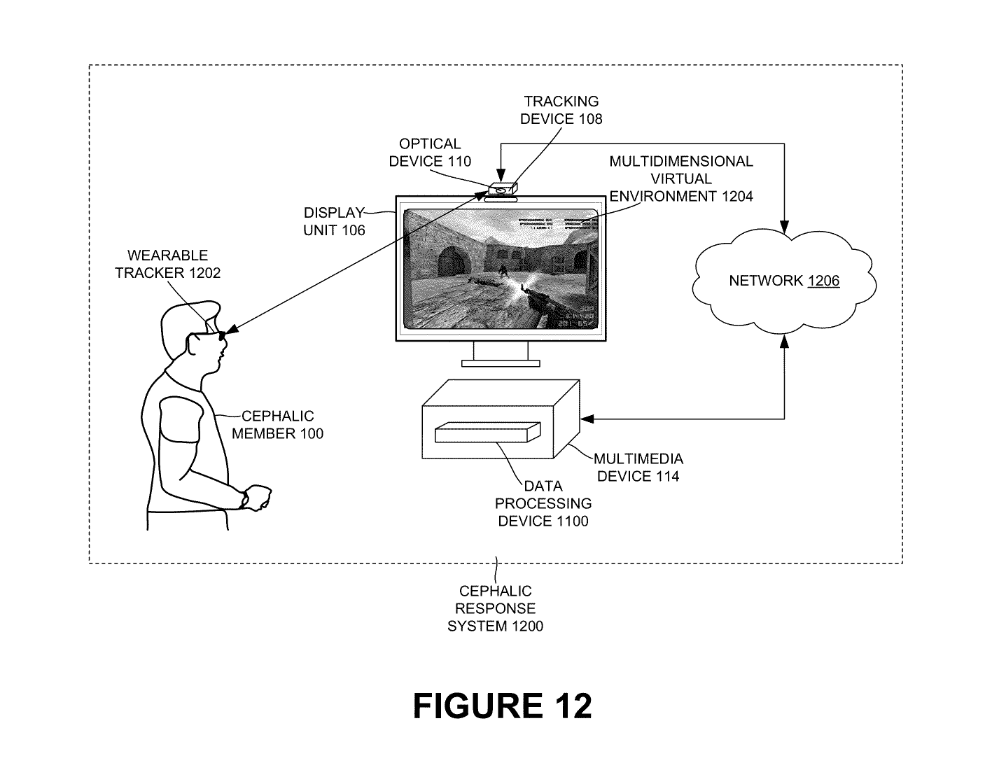

Reference is now made to FIG. 12 which is a schematic of a cephalic response system 1200, according to one embodiment. In one embodiment, the cephalic response system 1200 may comprise a tracking device 108, an optical device 110, a data processing device 1100, and a wearable tracker 1202. In one embodiment, the tracking device 108 may sit on top of the display 106 (as seen in FIG. 12). In another embodiment, the tracking device 108 may be embedded in the display unit 106 (e.g., in a TV, computer monitor, or thin client display). In one or more embodiments, the wearable tracker may be the wearable tracker 902 indicated in FIG. 10A. In other embodiments, the wearable tracker may be a wearable tracker without a gyroscope component.

In one embodiment, the tracking device 108 may detect the relative motion 102 of the cephalic member 100 of the human subject 112 using the optical device 110. In this embodiment, the optical device 110 of the tracking device 108 may determine an initial positional location of the cephalic member 100 of the human subject 112. The data processing device 1100 may then calculate a shift parameter based on an analysis of the relative motion 102 of the cephalic member 100 of the human subject 112 and reposition a multidimensional virtual environment 1204 based on the shift parameter using a multimedia processor inside the data processing device 1100. The multidimensional virtual environment 1204 may be repositioned such that the multidimensional virtual environment 1204 reflects a proportional visual response to the relative motion 102 of the cephalic member 100 of the human subject 112. In one embodiment, the multidimensional virtual environment 1204 is the multidimensional virtual environment 104 described in FIG. 1.

The wearable tracker 1202 may manifest an orientation change through a gyroscope component which permits the tracking device 108to detect the relative motion 102 of the cephalic member 100 of the human subject 112.In one embodiment, the tracking device 108 may detect an orientation change of the wearable tracker 1202 through at least one of an optical link, an infrared link, and a radio frequency link (e.g., Bluetooth®). In this same embodiment, the tracking device 108 may then transmit a motion data to the data processing device 1100 contained in a multimedia device 114. This transmission may occur through a network 1206. The network 1206 may comprise at least one of a wireless communication network, an optical or infrared link, and a radio frequency link (e.g., Bluetooth®). The wireless communication network may be a local, proprietary network (e.g., an intranet) and/or may be a part of a larger wide-area network.

In one embodiment, the multidimensional virtual environment 1204 repositioned may be a gaming environment. In another embodiment, the multidimensional virtual environment 1204 repositioned may be a computer assisted design (CAD) environment. In yet another embodiment, the multidimensional virtual environment 1204 repositioned may be a medical imaging and/or medical diagnostic environment.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. A method, comprising:
analyzing a relative motion of a cephalic member of a human subject;
calculating a shift parameter based on an analysis of the relative motion; and
repositioning a multidimensional virtual environment based on the shift parameter such that the multidimensional virtual environment reflects a proportional visual response to the relative motion of the cephalic member of the human subject using a multimedia processor, wherein the multimedia processor is at least one of a graphics processing unit, a visual processing unit, and a general purpose graphics processing unit.

2. The method of claim 1, further comprising:
calculating the shift parameter by determining an initial positional location of the cephalic member of the human subject through a tracking device and converting the relative motion to a motion data using the multimedia processor;
applying a repositioning algorithm to the multidimensional virtual environment based on the shift parameter; and
repositioning the multidimensional virtual environment based on a result of the repositioning algorithm.

3. The method of claim 2, further comprising:
determining the initial positional location by observing the cephalic member of the human subject through an optical device to capture an image of the cephalic member of the human subject;
calculating the initial positional location of the cephalic member of the human subject based on an analysis of the image; and
assessing that the cephalic member of the human subject is located at a particular region of the image through a focal-region algorithm.

4. The method of claim 3, further comprising:
determining that the relative motion is at least one of a flexion motion in a forward direction along a sagittal plane of the human subject, an extension motion in a backward direction along the sagittal plane of the human subject, a left lateral motion in a left lateral direction along a coronal plane of the human subject, a right lateral motion in a right lateral direction along the coronal plane of the human subject, and a circumduction motion along a conical trajectory.

5. The method of claim 4, further comprising:
converting at least one of the flexion motion to a forward motion data, the extension motion to a backward motion data, the left lateral motion to a left motion data, the right lateral motion to a right motion data, the circumduction motion to a circumduction motion data, the initial positional location to an initial positional location data using the multimedia processor;
calculating a change in a position of the cephalic member of the human subject by analyzing at least one of the forward motion data, the backward motion data, the left motion data, the right motion data, the circumduction motion data, and the initial positional location data using the multimedia processor;
selecting a multidimensional virtual environment data from a non-volatile storage, wherein the multidimensional virtual environment data is based on the multidimensional virtual environment displayed to the human subject through a display unit at an instantaneous time of the relative motion;
applying the repositioning algorithm to the multidimensional virtual environment data selected from the non-volatile storage based on at least one of the forward motion data, the backward motion data, the left motion data, the right motion data, and the circumduction motion data when compared against the initial positional location data; and
introducing a repositioned multidimensional virtual environment data to a random access memory.

6. The method of claim 5, further comprising:
detecting the relative motion of the cephalic member of the human subject through the tracking device by sensing an orientation change of a wearable tracker, wherein:
the wearable tracker is comprised of a gyroscope component configured to manifest the orientation change which permits the tracking device to determine the relative motion of the cephalic member of the human subject,
the relative motion of the cephalic member of the human subject is a continuous motion and a perspective of the multidimensional virtual environment is repositioned continuously and in synchronicity with the continuous motion, and
the tracking device is at least one of a stand-alone web camera, an embedded web camera, and a motion sensing device.

7. The method of claim 6, wherein:
the multidimensional virtual environment comprises at least a three dimensional virtual environment and a two dimensional virtual environment.

8. A data processing device, comprising:
a non-volatile storage to store a multidimensional virtual environment;
a multimedia processor to calculate a shift parameter based on an analysis of a relative motion of a cephalic member of a human subject,
wherein the multimedia processor is configured to determine that the relative motion is at least one of a flexion motion in a forward direction along a sagittal plane of the human subject, an extension motion in a backward direction along the sagittal plane of the human subject, a left lateral motion in a left lateral direction along a coronal plane of the human subject, a right lateral motion in a right lateral direction along the coronal plane of the human subject, and a circumduction motion along a conical trajectory; and
a random access memory to maintain the multidimensional virtual environment repositioned by the multimedia processor based on the shift parameter such that the multidimensional virtual environment repositioned by the multimedia processor reflects a proportional visual response to the relative motion of the cephalic member of the human subject.

9. The data processing device of claim 8, wherein:
the multimedia processor is configured:
to determine an initial positional location of the cephalic member of the cephalic member of the human subject through a tracking device, to convert the relative motion to a motion data using the multimedia processor,
to apply a repositioning algorithm to the multidimensional virtual environment based on the shift parameter, and
to reposition the multidimensional virtual environment based on a result of the repositioning algorithm.

10. The data processing device of claim 9, wherein:
the multimedia processor is configured to operate in conjunction with an optical device:
to determine the initial positional location of the cephalic member of the human subject based on an analysis of an image, and
to assess that the cephalic member of the human subject is located at a particular region of the image through a focal-region algorithm.

11. The data processing device of claim 10, wherein:
the multimedia processor is configured:
to convert at least one of the flexion motion to a forward motion data, the extension motion to a backward motion data, the left lateral motion to a left motion data, the right lateral motion to a right motion data, the circumduction motion to a circumduction motion data, and the initial positional location to an initial positional location data using the multimedia processor,
to calculate a change in a position of the cephalic member of the human subject by analyzing at least one of the forward motion data, the backward motion data, the left motion data, the right motion data, the circumduction motion data, and the initial positional location data using the multimedia processor,
to select a multidimensional virtual environment data from the non-volatile storage, wherein the multidimensional virtual environment data is based on the multidimensional virtual environment displayed to the human subject through a display unit at an instantaneous time of the relative motion,
to apply the repositioning algorithm to the multidimensional virtual environment data selected from the non-volatile storage based on at least one of the forward motion data, the backward motion data, the left motion data, the right motion data, and the circumduction motion data when compared against the initial positional location data, and
to introduce a repositioned multidimensional virtual environment data to the random access memory of the data processing device.

12. The data processing device of claim 11, wherein:
the multimedia processor is at least one of a graphics processing unit, a visual processing unit, and a general purpose graphics processing unit.

13. The data processing device of claim 12, wherein:
the multimedia processor is configured to detect the relative motion of the cephalic member of the human subject through an input from the tracking device by sensing an orientation change of a wearable tracker;
the wearable tracker is comprised of a gyroscope component configured to manifest the orientation change which permits the data processing device to determine the relative motion of the cephalic member of the human subject;
the relative motion of the cephalic member of the human subject is a continuous motion and a perspective of the multidimensional virtual environment is repositioned continuously and in synchronicity with the continuous motion,
the tracking device is at least one of a stand-alone web camera, an embedded web camera, and a motion sensing device; and
the multidimensional virtual environment comprises at least a three dimensional virtual environment and a two dimensional virtual environment.

14. A cephalic response system, comprising:
a tracking device to detect a relative motion of a cephalic member of a human subject;
an optical device to determine an initial positional location of the cephalic member of the human subject;
a data processing device to calculate a shift parameter based on an analysis of the relative motion of the cephalic member of the human subject and to reposition a multidimensional virtual environment based on the shift parameter using a multimedia processor such that the multidimensional virtual environment reflects a proportional visual response to the relative motion of the cephalic member of the human subject; and
a wearable tracker to manifest an orientation change which permits the data processing device to detect the relative motion of the cephalic member of the human subject.

15. The cephalic response system of claim 14, wherein:
the data processing device is configured:
to determine the initial positional location of the cephalic member of the human subject through the tracking device;
to convert the relative motion to a motion data using the multimedia processor;
to apply a repositioning algorithm to the multidimensional virtual environment based on the shift parameter; and
to reposition the multidimensional virtual environment based on a result of the repositioning algorithm.

16. The cephalic response system of claim 15, wherein
the data processing device operates in conjunction with the optical device to determine the initial positional location of the cephalic member of the human subject based on an analysis of an image captured by the optical device and to assess that the cephalic member of the human subject is located at a particular region of the image through a focal-region algorithm.

17. The cephalic response system of claim 16, wherein:
the relative motion is at least one of a flexion motion in a forward direction along a sagittal plane of the human subject, an extension motion in a backward direction along the sagittal plane of the human subject, a left lateral motion in a left lateral direction along a coronal plane of the human subject, a right lateral motion in a right lateral direction along the coronal plane of the human subject, and a circumduction motion along a conical trajectory.

18. The cephalic response system of claim 17, wherein:
the data processing device is configured:
to convert at least one of the flexion motion to a forward motion data, the extension motion to a backward motion data, the left lateral motion to a left motion data, the right lateral motion to a right motion data, the circumduction motion to a circumduction motion data, and the initial positional location to an initial positional location data using the multimedia processor,
to calculate a change in a position of the cephalic member of the human subject by analyzing at least one of the forward motion data, the backward motion data, the left motion data, the right motion data, the circumduction motion data, and the initial positional location data using the multimedia processor,
to select a multidimensional virtual environment data from a non-volatile storage, wherein the multidimensional virtual environment data is based on the multidimensional virtual environment displayed to the human subject through a display unit at an instantaneous time of the relative motion,
to apply the repositioning algorithm to the multidimensional virtual environment data selected from the non-volatile storage based on at least one of the forward motion data, the backward motion data, the left motion data, the right motion data, and the circumduction motion data when compared against the initial positional location data, and
to introduce a repositioned multidimensional virtual environment data to a random access memory of the data processing device.

19. The cephalic response system of claim 18, further comprising:
a gyroscope component embedded in the wearable tracker and configured to manifest the orientation change which permits the data processing device to determine the relative motion of the cephalic member of the human subject.

20. The cephalic response system of claim 19, wherein:
the relative motion of the cephalic member of the human subject is a continuous motion and a perspective of the multidimensional virtual environment is repositioned continuously and in synchronicity with the continuous motion;
the tracking device is at least one of a stand-alone web camera, an embedded web camera, and a motion sensing device; and
the multidimensional virtual environment comprises at least a three dimensional virtual environment and a two dimensional virtual environment.
